(19) United States
(12) Patent Application Publication
(10) Pub. No.: US 2010/0219558 A1
(43) Pub. Date: Sep. 2, 2010

(54) MELT EXTRUDER AND PROCESS FOR PRODUCING THERMOPLASTIC RESIN FILM

(75) Inventor: Akihide Fujita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/680,505

(22) PCT Filed: Sep. 16, 2008
(86) PCT No.: PCT/JP2008/066651

§ 371 Date: Mar. 26, 2010

(30) Foreign Application Priority Data
Sep. 28, 2007 (JP) 2007-256698

(51) Int. Cl. B29C 47/88; B01F 15/06

(52) U.S. Cl. 264/211.12; 366/145

(57) ABSTRACT

When amorphous thermoplastic resin is supplied from a hopper, the resin is rotated by a screw in a barrel and generates frictional heat. In this point of view, in a melt extruder according to an aspect of the present invention, a temperature control zone that generates particularly high frictional heat is constantly cooled by a cooling device, and heated by a heating device to obtain a target temperature, thereby significantly reducing variations in barrel temperature. This can stabilize screw tip pressure, and reduce variations in thickness of a resin film discharged from the barrel.

### TECHNICAL FIELD

The present invention relates to a melt extruder and a process for producing a thermoplastic resin film, and more particularly to a melt extruder and a process for producing a thermoplastic resin film applied to amorphous thermoplastic resin.

### BACKGROUND ART

A cellulosic resin film such as a cellulose acylate film of thermoplastic resin is formed in such a manner that a melt extruder melts cellulosic resin and extrudes the resin into a die, and discharges the molten resin from the die into a film shape and cools and solidifies the resin.

To maintain constant quality of the thermoplastic resin film, the melt extruder is divided into a plurality of temperature control zones, and each temperature control zone is controlled to be a target temperature. Concerning a temperature control device of a melt extruder, Patent Document 1 discloses that a heater is placed around a barrel, a channel for a cooling medium is provided around the heater, and when a resin temperature exceeds a target value, the cooling medium is supplied to the channel to control the temperature.

Also, Patent Document 2 discloses that a heater is placed on an outer periphery of a barrel, and cooling water is circulated in a screw incorporated into the barrel to control the temperature.
Patent Document 1: Japanese Patent Application Laid-Open No. 2004-314399
Patent Document 2: Japanese Patent Application Laid-Open No. 10-109351

### DISCLOSURE OF THE INVENTION

### Problems to be Solved by the Invention

When amorphous thermoplastic resin is melt-extruded by a melt extruder, variations in barrel temperature in a supply portion causes variations in screw tip pressure. Thus, temperature adjustment in the supply portion is important.

However, in the melt extruder in Patent Document 1, the barrel is abruptly cooled when the cooling medium is supplied to the channel, which causes large temperature variations until a constant temperature is reached.

Also, in the melt extruder in Patent Document 2, the cooling water circulated in the screw is used for cooling, and thus molten resin is susceptible to the temperature of the cooling water and precise control of the barrel temperature is difficult.

The present invention is achieved in view of such circumstances, and has an object to provide a melt extruder with small variations in barrel temperature and small variations in screw tip pressure, and a process for producing a thermoplastic resin film using the apparatus.

### Means for Solving the Problems

To achieve the object, a first aspect of the present invention provides a melt extruder including: a barrel; a screw incorporated into the barrel; a hopper that is provided in a base end of the barrel and supplies amorphous thermoplastic resin; a discharge port of molten resin provided in a tip of the barrel; and a temperature detection device, a heating device surrounding the barrel, and a cooling device surrounding the heating device, which are provided in a plurality of temperature control zones divided along a length of the barrel, wherein the cooling device and the heating device are controlled so that the cooling device constantly performs cooling and the heating device performs heating to obtain a target temperature in at least one temperature control zone located on the side of the hopper.

When the amorphous thermoplastic resin is supplied from the hopper, the resin is rotated by the screw in the barrel and generates frictional heat. In this point of view, in the present invention, a temperature control zone that generates particularly high frictional heat is constantly cooled by the cooling device, and heated by the heating device to obtain the target temperature, thereby significantly reducing variations in barrel temperature. This can stabilize screw tip pressure, and reduce variations in thickness of a resin film discharged from the barrel.

In a melt extruder according to a second aspect of the present invention, the heating device has a system that controls an output of a heater with an AC power adjustor in the first aspect. The output is controlled by the AC power adjustor and thus can be continuously changed. This allows accurate temperature control.

In a melt extruder according to a third aspect of the present invention, an average value of the output of the heater is 10% to 90% in the second aspect. The average value of 10% to 90% of the output of the heater allows control with quick response.

In a melt extruder according to a fourth aspect of the present invention, the cooling device is controlled to constantly perform cooling with a medium at a constant flow rate and a constant temperature in the first to third aspects. Constantly performing cooling with the medium at the constant flow rate and the constant temperature allows temperature control with a relatively simple cooling device and control system.

In a melt extruder according to a fifth aspect of the present invention, the cooling device is controlled to change at least one of the flow rate and the temperature of the medium based on a detection result of the temperature detection device and constantly perform cooling in the first to third aspects. The flow rate or the temperature is changed based on the detection result of the temperature detection device that detects the barrel temperature, thereby reducing an operating rate of the heating device, and allowing temperature control with high accuracy.

In a melt extruder according to a sixth aspect of the present invention, the apparatus further includes a temperature detection device that detects a temperature difference between entering and returning of the medium of the cooling device, and the cooling device is controlled to change at least one of the flow rate and the temperature of the medium based on a detection result of the temperature detection device and constantly perform cooling in the first to third aspects.

The temperature difference between entering and returning of the medium is detected, and the flow rate or the temperature of the medium is changed based on the result, thereby allowing temperature control with high accuracy.

In a melt extruder according to a seventh aspect of the present invention, the medium is a coolant in the fourth to sixth aspects.

In a melt extruder according to an eighth aspect of the present invention, the medium is air in the fourth to sixth aspects.

The media suitable for the cooling device are defined above.

A ninth aspect of the present invention provides a process for producing a thermoplastic resin film including the steps of: melting thermoplastic resin and melt-extruding the resin from a die into a film shape using a melt extruder according to any one of the first to eighth aspects; casting the melt-extruded film-shaped thermoplastic resin; and winding up the casted thermoplastic resin.

In the ninth aspect, the melt extruder according to any one of the first to eighth aspects can be used to stabilize screw tip pressure and obtain a thermoplastic resin film with small variations in thickness.

### Advantage of the Invention

According to the present invention, melt extrusion of thermoplastic resin can be performed with very small variations in barrel temperature and stable screw tip pressure.

### BRIEF DESCRIPTION OF THE DRAWINGS

FIG. 1 is a schematic configuration diagram of a melt extrusion apparatus; and

FIG. 2 is a configuration diagram of a film production device to which the present invention is applied.

### DESCRIPTION OF SYMBOLS

10 melt extruder
12 barrel
14 screw
16 thermoplastic resin
18 hopper
20, 22, 24, 26, 28 heating device
30, 32, 34, 36, 38 cooling device
40, 42, 44, 46, 48 temperature detection device
50, 52, 54, 56, 58 temperature control device
60 supply port
62 discharge port
64 pipe
66 die
68, 70, 72 cooling roller
74 peeling roller
76 winder

### BEST MODE FOR CARRYING OUT THE INVENTION

The present invention will be described with the preferred embodiment below. However, changes may be made in various manners without departing from the scope of the present invention, and embodiments other than this embodiment may be used. Thus, all changes within the scope of the present invention are covered by claims. In the specification, a numerical value range indicated with “to” refers to a range including numerical values before and after “to”.

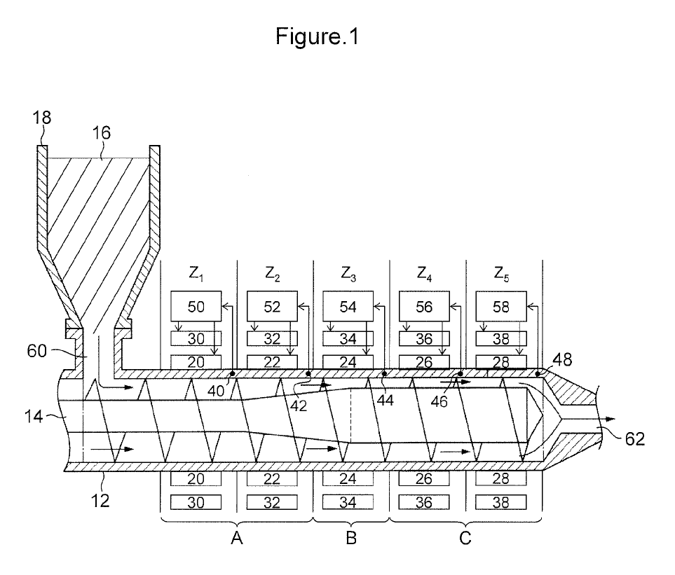

FIG. 1 is a schematic configuration diagram of a melt extruder according to the present invention. A melt extruder 10 includes a barrel 12, and a screw 14 incorporated into the barrel 12. The screw 14 is connected at its base end to an unshown screw drive motor, and rotationally driven by the screw drive motor.

A hopper 18 for supplying amorphous thermoplastic resin 16 to the barrel 12 is mounted to a base end of the barrel 12. The thermoplastic resin 16 in pellets form is supplied to the hopper 18.

The barrel 12 is divided into a plurality of temperature control zones, for example, Z1 to Z5 in a longitudinal direction. Heating devices 20, 22, 24, 26 and 28 are provided to surround the barrel 12 correspondingly to the temperature control zones Z1 to Z5, respectively. Cooling devices 30, 32, 34, 36 and 38 are provided to surround the heating devices 20, 22, 24, 26 and 28. Similarly, temperature detection devices 40, 42, 44, 46 and 48 that detect the temperature of the barrel 12 are provided in the barrel 12 correspondingly to the temperature control zones Z1 to Z5, respectively. Temperature control devices 50, 52, 54, 56 and 58, which control the cooling devices 30, 32, 34, 36 and 38 and the heating devices 20, 22, 24, 26 and 28 based on detection results of the temperature detection devices 40, 42, 44, 46 and 48, are provided.

The inside of the barrel 12 includes, in order from a supply port 60, a supply portion (region indicated by A) that dispenses resin supplied from the supply port 60, a compression portion (region indicated by B) that kneads and compresses the resin; and a measuring portion that measures the kneaded and compressed resin (region indicated by C). A discharge port 62 for discharging molten resin fed by the screw 14 is provided in a tip of the barrel 12.

An operation of the melt extruder thus configured will be described. The amorphous thermoplastic resin 16, for example, cellulose acylate resin is supplied from the hopper 18 through the supply port 60 into the barrel 12. The thermoplastic resin 16 is melted and kneaded by the screw 14 in the barrel 12 controlled in temperature by the temperature control devices 50, 52, 54, 56 and 58 and extruded to the discharge port 62 of the barrel 12.

In the temperature control zones Z1 to Z5, based on the detection results of the temperature detection devices 40, 42, 44, 46 and 48, the temperature control devices 50, 52, 54, 56 and 58 control the cooling devices 30, 32, 34, 36 and 38 and the heating devices 20, 22, 24, 26 and 28 to obtain each target temperature.

In an example of the temperature control zone Z1, a detection result of the temperature detection device 40 provided in the barrel 12 is output to the temperature control device 50. The temperature control device 50 compares an output value (barrel temperature) of the temperature detection device 40 with a set target temperature and calculates a corrected value. The temperature control device 50 controls to drive the heating device 20 and the cooling device 30 based on the corrected value. The set target temperature is different depending on the temperature control zones.

In the present invention, in Z1 and Z2 corresponding to the supply portion A, the temperature control devices 50 and 52 control the cooling device and the heating device so that the cooling devices 30 and 32 constantly perform cooling and the heating devices 20 and 22 perform heating to obtain a target temperature.

A conventional temperature control device controls a cooling device by an on/off control system and a heating device by an on/off control system or a variable output system to obtain a target temperature. Specifically, based on a detection result of the temperature detection device, the cooling device is turned on and the heating device is turned off when the temperature is higher than the target temperature, and the cooling device is turned off and the heating device is turned on when the temperature is lower than the target temperature.

When amorphous thermoplastic resin is melted and extruded by a melt extruder, the temperature of a supply portion is often higher than the target temperature by frictional heat of a screw, a barrel and resin. Even if the melt extruder includes the cooling device and the heating device around the barrel, only the cooling device is substantially turned on/off in the supply portion, and the heating device is rarely turned on. Thus, only the cooling device low in operating rate is driven in the supply portion, causing large variations in barrel temperature with respect to the target temperature.

Since the variations in barrel temperature in the supply portion causes pressure variations of a screw tip that causes variations in film thickness, preventing the variations in barrel temperature in the supply portion is important for a stable thermoplastic resin film.

In the present invention, it has been found that the cooling device and the heating device are controlled so that the cooling device constantly performs cooling and the heating device performs heating to obtain a target temperature in view of frictional heat in the temperature control zone corresponding to the supply portion.

Meanwhile, since the cooling device constantly performs cooling in the temperature control zone corresponding to the supply portion, the cooling device is placed to surround the heating device placed around the barrel to avoid variations in barrel temperature due to supercooling.

Next, a preferred control method of the cooling device and the heating device applied to the melt extruder will be described.

The heating devices 20 and 22 applied to the melt extruder preferably have a system that controls an output of a heater with an AC power adjustor. The output is controlled by the AC power adjustor and thus can be continuously changed, and this allows accurate temperature control.

An average value of the output of the heater of the heating devices 20 and 22 is preferably 10% to 90%. The average value of 10% to 90% of the output of the heater allows control with quick response. In this term, the average value of the heater is further preferably 5% to 30%.

The temperature control devices 50 and 52 preferably constantly perform cooling by passing a medium at a constant flow rate and a constant temperature. The temperature of the supply portion can be controlled by a relatively simple cooling device and control system. For example, as the cooling devices 30 and 32 placed around the heating devices 20 and 22, a channel of the medium is formed, and air or a coolant at a constant flow rate and a constant temperature is passed through the channel to easily achieve constant cooling.

Then, at least one of the flow rate and the temperature of the medium of the cooling devices 30 and 32 is changed based on the detection result of the temperature detection devices 40 and 42 to allow temperature control with high accuracy. As combinations thereof, it is supposed that (1) the medium at the constant flow rate is passed, the temperature of the barrel is detected, and the temperature of the medium is changed, (2) the medium at the constant temperature is passed, the temperature of the barrel is detected, and the flow rate is changed, and (3) the temperature of the barrel is detected, and the flow rate and the temperature of the coolant are changed.

The combination (1) can be easily achieved by changing the control system of the temperature control devices 50 and 52, and providing a valve in the channel of the medium. The combination (2) can be easily achieved by changing the control system of the temperature control devices 50 and 52, and providing a temperature adjustment device in the channel of the medium. The combination (3) can be easily achieved by changing the control system of the temperature control devices 50 and 52, and providing the valve and the temperature adjustment device in the channel of the medium.

Then, a temperature detection device that detects a temperature difference between entering and returning of the medium of the cooling device may be provided for cascade control including a control loop that changes at least one of the flow rate and the temperature of the medium based on the detection result of the temperature detection device, thereby allowing temperature control with higher accuracy.

This can be easily achieved by changing the control system of the temperature control devices 50 and 52, and providing the temperature detection device that detects a temperature difference between entering and returning of the medium of the cooling device.

As the medium of the cooling device, a coolant or air can be suitably used. For example, water or brine can be used as the coolant. Also, air or nitrogen can be used as the air.

When the temperature was controlled by the conventional melt extruder, temperature variations of the supply portion were ±3° C. Meanwhile, when the present invention was used, temperature variations of the supply portion were ±0.6° C. According to the present invention, the variations were reduced by ⅕, and variations in screw tip pressure were reduced by ⅛.

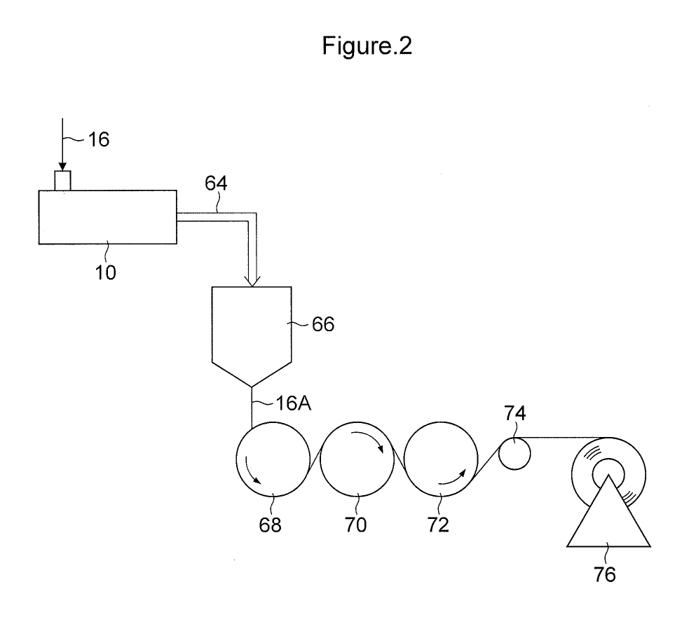

Finally, a process for producing a thermoplastic resin film to which the melt extrusion apparatus of the present invention is applied will be described with reference to FIG. 2.

As shown in FIG. 2, a production device of a thermoplastic resin film mainly includes a melt extruder 10 that melts thermoplastic resin 16, a die 66 that melt-extrudes the molten thermoplastic resin 16 into a film shape, a plurality of cooling rollers 68, 70 and 72 that cool a hot thermoplastic resin film 16A (hereinafter referred to as film 16A) discharged from the die 66 in multiple stages, a peeling roller 74 that peels the film 12A from the final cooling roller 72, and a winder 76 that winds up the cooled film 16A.

The thermoplastic resin 16 melted by the melt extruder 10 is fed via a pipe 64 to the die 66, and discharged from a discharge port of the die 66 into a film shape. Then, the hot film 16A discharged from the die 66 is cooled in multiple stages by three cooling rollers 68, 70 and 72 arranged in multiple stages. The film 16A is cooled and solidified by the three cooling rollers 68, 70 and 72 and conveyed. The cooled film 16A is wound up by the winder 76. As required, to cause retardation in the film, a step of lateral stretching or vertical stretching is introduced before winding up by the winder 76.

The melt extruder can be used to stabilize screw tip pressure, and obtain a thermoplastic resin film 16A with small variations in thickness.

1. A melt extruder comprising:
a barrel;
a screw incorporated into the barrel;
a hopper that is provided in a base end of the barrel and supplies amorphous thermoplastic resin;
a discharge port of molten resin provided in a tip of the barrel; and
a first temperature detection device, a heating device surrounding the barrel, and a cooling device surrounding the heating device, which are provided in a plurality of temperature control zones divided along a length of the barrel,
wherein the cooling device and the heating device are controlled so that the cooling device constantly performs cooling and the heating device performs heating to obtain a target temperature in at least one temperature control zone located on a side of the hopper.

2. The melt extruder according to claim 1, wherein the heating device has a system that controls an output of a heater with an AC power adjustor.

3. The melt extruder according to claim 2, wherein an average value of the output of the heater is 10% to 90%.

4. The melt extruder according to claim 1, wherein the cooling device is controlled to constantly perform cooling with a medium at a constant flow rate and a constant temperature.

5. The melt extruder according to claim 1, wherein the cooling device is controlled to change at least one of the flow rate and the temperature of the medium based on a detection result of the first temperature detection device and constantly perform cooling.

6. The melt extruder according to claim 1, further comprising a second temperature detection device that detects a temperature difference between entering and returning of the medium of the cooling device, wherein
the cooling device is controlled to change at least one of the flow rate and the temperature of the medium based on a detection result of the second temperature detection device and constantly perform cooling.

7. The melt extruder according to claim 4, wherein the medium is a coolant.

8. The melt extruder according to claim 4, wherein the medium is air.

9. A process for producing a thermoplastic resin film comprising the steps of:
melting thermoplastic resin and melt-extruding the resin from a die into a film shape using a melt extruder according to claim 1;
casting the melt-extruded film-shaped thermoplastic resin; and
winding up the casted thermoplastic resin.

10. The melt extruder according to claim 3, wherein the cooling device is controlled to constantly perform cooling with a medium at a constant flow rate and a constant temperature.

11. The melt extruder according to claim 3, wherein the cooling device is controlled to change at least one of the flow rate and the temperature of the medium based on a detection result of the first temperature detection device and constantly perform cooling.

12. The melt extruder according to claim 3, further comprising a second temperature detection device that detects a temperature difference between entering and returning of the medium of the cooling device, wherein
the cooling device is controlled to change at least one of the flow rate and the temperature of the medium based on a detection result of the second temperature detection device and constantly perform cooling.

13. The melt extruder according to claim 5, wherein the medium is a coolant.

14. The melt extruder according to claim 6, wherein the medium is a coolant.

15. The melt extruder according to claim 10, wherein the medium is a coolant.

16. The melt extruder according to claim 11, wherein the medium is a coolant.

17. The melt extruder according to claim 12, wherein the medium is a coolant.

18. The melt extruder according to claim 5, wherein the medium is air.

19. The melt extruder according to claim 6, wherein the medium is air.

20. The melt extruder according to claim 10, wherein the medium is air.

21. The melt extruder according to claim 11, wherein the medium is air.

22. The melt extruder according to claim 12, wherein the medium is air.
